(19) United States
(12) Patent Application Publication
(10) Pub. No.: US 2019/0277441 A1
(43) Pub. Date: Sep. 12, 2019

(54) CELLYPOD - MOBILE COMPUTING OR COMMUNICATIONS DEVICE STAND

(71) Applicants: Stormy Maratas, Oakland, CA (US); Christopher Maratas, Oakland, CA (US)

(72) Inventors: Stormy Maratas, Oakland, CA (US); Christopher Maratas, Oakland, CA (US)

(21) Appl. No.: 16/276,578

(22) Filed: Feb. 14, 2019

Related U.S. Application Data
(60) Provisional application No. 62/734,983, filed on Sep. 21, 2018.
(60) Provisional application No. 62/631,486, filed on Feb. 15, 2018.

(51) Int. Cl. F16M 11/04; H04M 1/04; F16B 1/00; F16M 11/14; G06F 1/16

(52) U.S. Cl. CPC F16M 11/041; H04M 1/04; F16B 1/00; F16M 2200/08; G06F 1/1632; F16B 2001/0035; F16M 11/14

(57) ABSTRACT

A mobile computing device stand includes a padded cushion, a stabilizing plate attached or connected to the padded cushion, a vertical support assembly attached or connected to the stabilizing plate, and a pivoting disk assembly attached or connected to the vertical support assembly, the pivoting disk assembly to magnetically attach to the mobile computing device. The vertical support assembly includes a vertical stand and a circular joint, the vertical stand is connected to the stabilizing plate and the circular joint is connected on one end to the vertical stand and is attached to the pivoting disk assembly on a second end.

### RELATED APPLICATIONS

This application claims priority to U.S. provisional patent application 62/734,983, filed Sep. 21, 2018, entitled “CellypodP2” and U.S. provisional application for patent Ser. No. 62/631,486, filed Feb. 15, 2018 and entitled “Cellypod,” the disclosures of which are both herein incorporated by reference.

### BACKGROUND OF THE INVENTION

A mobile computing or communications device (e.g., such as a tablet computing device, a smartphone, or a mobile computing device) lacks a structure to allow the mobile computing communications device to stand up on its own. This presents a problem because a significant portion of daily use of mobile computing or communication devices may occur as a user wakes up and/or before going to sleep. In these situations, a user may be lying in a bed or sitting up on a bed or a couch. Thus, a user may hold up the mobile computing or communications device by the user's hand or by resting the mobile computing or communications device on a user's chest or stomach. This is not preferable because the user does not have both hands to work with and/or also because the mobile computing or communications device may not be adjustable to a correct orientation while standing up on its own.

### BRIEF DESCRIPTION OF DRAWINGS

FIG. 1A illustrates a mobile computing device stand according to embodiments;

FIG. 1B illustrates a padded cushion according to embodiments;

FIG. 2 illustrates another mobile computing device stand according to embodiments;

FIG. 3 illustrates a mobile computing device stand including a wedge shaped padded cushion according to embodiments;

FIG. 4 illustrates an additional embodiment of a mobile computing device stand according to additional embodiments;

FIG. 5A illustrates a foam covering a stabilizing plate in a mobile computing device stand according to embodiments;

FIG. 5B illustrates weights or weighted washers placed on a stabilizing plate in a mobile computing device stand according to embodiments; and

FIG. 5C illustrates an additional embodiment of a mobile computing device stand including foam padding according to embodiments

### DETAILED DESCRIPTION

The foregoing, and other features and advantages of the invention and claimed subject matter, will be apparent from the following, more particular description of the preferred embodiments of the invention and claimed subject matter, the accompanying drawings, and the claims.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn. Mobile computing device and/or mobile communications device may be used interchangeably herein to refer to a computing device that is portable that includes computing (e.g., processing capability) and/or communications capability (e.g., both cellular and data communications).

In some embodiments, a mobile computing device stand may be a padded cushion stand that may comfortably be placed on a chest or a stomach of a user while laying prone on a bed or a couch. In embodiments, a mobile computing device stand may rest on a bed or couch by itself. In embodiments, a mobile computing device stand may comprise an outer shell enclosing a soft weighted filler and/or a cushion in the shape of a small wedge allowing for additional viewing angles. In embodiments, an adjustable gripping member (e.g., utilizing either magnetic, spring tension, Velcro or rubber straps to hold the mobile computing device) is positioned on a vertical support stand and/or a pivoting joint atop the outer shell for supporting the mobile computing device. The support for the mobile computing device may be in both the landscape and/or portrait orientation and/or many degrees in between. In embodiments, a stabilizing plate is engaged against the filler to spread the weight of the mobile computing device across a large enough area of the soft filler to stably support the mobile computing device. In embodiments, the stabilizing plate may be positioned or located inside the outer shell of the padded cushion. In embodiments, due to close proximity of the mobile computing device to a user's body and potential radiation being generated by an antenna and/or mobile computing device, an outer shell may include a thin and flexible radiation fabric shield. In embodiments, a mobile computing device stand may also lift a mobile computing device higher for reducing neck strain.

Previous designs focused on providing support for a desktop computer and so were more focused on having a flat surface that it adequately supported. Desktop or large laptop computers with large screens require a significant amount of support and thus cannot be connected in a vertical fashion that is convenient to a user when a user or operator is lying down on a bed and/or a sofa. Other designs focused on supporting mobile devices in vehicles such as cars where large support structures (dashboards, doors, or windows) are available to hold a device (either directly or indirectly) via a support assembly that is attached to a large support structure (e.g., dashboard, door or window). In addition, the vehicle support devices are not mobile and are tied to being utilized within the mobile vehicle. There are portable magnetic device stands that are marketed for use at one's desk.

In embodiments, a mobile computing device stand may allow a user to attach and/or connect a mobile computing device to the mobile computing device stand and be able to utilize and/or access the mobile computing device while lying in bed. In embodiments, a mobile computing device stand may be placed on a stomach and/or chest of a user. In embodiments, a mobile computing device stand may be placed on a bed or couch on which a user is lying or lying prone. The stand allows the user to not have to utilize a hand to hold the mobile computing device while being able to interface with the mobile device stands.

In embodiments, a mobile computing device may comprise a smart phone, a tablet, a network computer, Kindle, an iPAD®, small laptop computers without support and/or other one non-hinged computing devices. In embodiments, a mobile computing device may weigh between 3 to 10 ounces (or 85 to 285 grams) and may have a display between 4 and 7 inches diagonal. In embodiments, a mobile computing device may have a height between 4.5 to 9 inches, a width of between 3 to 6 inches and a depth of 0.3 to 0.8 inches. In embodiments, a mobile computing device such as a tablet may have a weight between 0.8 to 1.5 pounds, may have a display size between 5 to 13 inches diagonal, may have a height between 7 inches to 12 inches, a width between 4 inches to 7.5 inches and/or a depth of 0.4 to 1.0 inch.

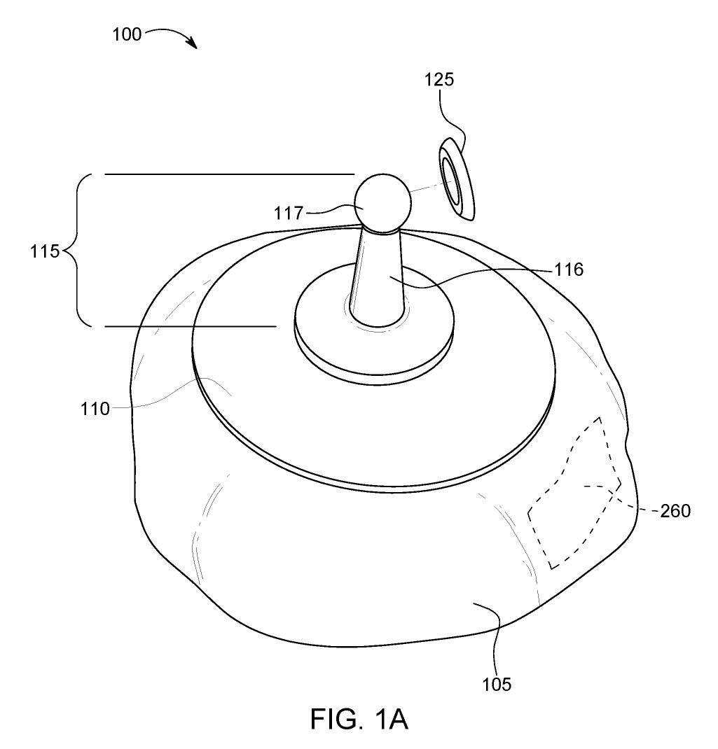

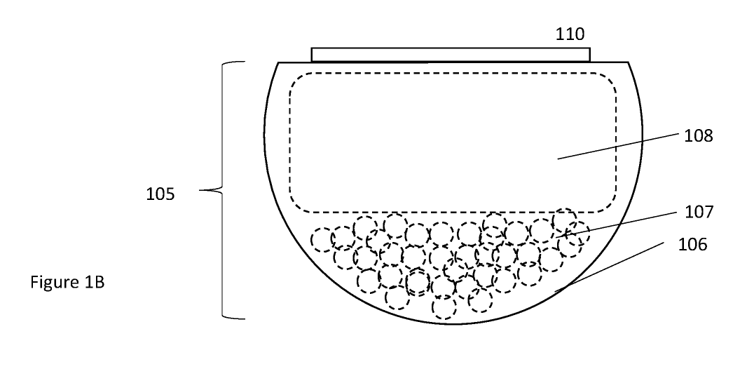

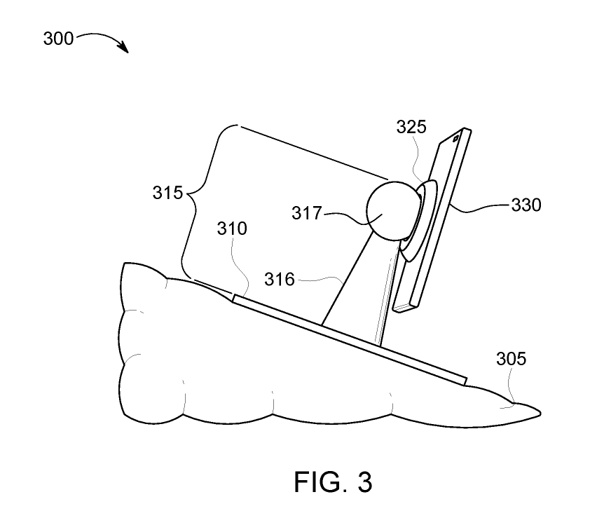

FIG. 1A illustrates a mobile computing device stand according to embodiments. A mobile computing device stand 100 may comprise a padded cushion 105, a stabilizing plate 110, a vertical support assembly 115 including a vertical stand 116, and/or a circular joint or ball 117. In embodiments, a mobile computing device may be attached to and/or connected to a pivoting joint or disk assembly 125 of the mobile computing device stand 100. In embodiments, a padded cushion 105 may comprise an outer shell 106 enclosing a filling material 107 and/or memory foam 108. In embodiments, a padded cushion 105 may comprise a wedge-shaped base, which is illustrated in FIG. 3. In embodiments, a padded cushion 105 may be circular, oval or rectangular in shape. In embodiments, dimensions of a padded cushion may have a circumference between 18 inches and 30 inches with a depth or height of between 3 inches and 6 inches. In embodiments, dimensions of a rectangular padded cushion 105 may range between 7 inches and 12 inches in length and/or width, and may have a depth or height with a range of 2 inches to 5 inches.

FIG. 1B illustrates a padded cushion according to embodiments. In embodiments, a filling material 107 may be soft and/or weighted. Examples of a suitable fillable material 107 may be weighted beads, rice, beans, sand, glass beads, and/or plastic pellets (e.g., Poly Pellets). In embodiments, memory foam 108 may be surrounded by a fillable material such as weighted beads in a padded cushion. FIG. 1B illustrates that a padded cushion 105 may comprise both a filling material 107 and/or a memory foam 108. In embodiments, a padded cushion 105 may comprise a filling material 107 only. In embodiments, a padded cushion 105 may comprise a memory foam 108 only.

In embodiments, an outer shell 106 may comprise a nylon fabric, a cotton fabric, a polyester fabric, a silk fabric, a linen fabric, a wool fabric, a leather fabric, a faux leather fabric, an acrylic fabric, a velvet fabric, a denim fabric, a rayon fabric, a spandex fabric, a plastic fabric, and/or a jute fabric, and, a blend of the above-identified fabrics. In embodiments, a padded cushion 105 may have a range of between 7 and 12 inches in length or width and/or may have a depth or height with a range of 2 inches to 5 inches.

In embodiments, a stabilizing plate 110 may be attached to a top surface of a padded cushion 105 (or wedge-shaped padded cushion 105). In embodiments, a stabilizing plate 110 may be attached via an adhesive to a top surface of a padded cushion 105. In embodiments, a stabilizing plate 110 may be stitched to a top surface of a padded cushion 105 or may be connected to a top surface of a padded cushion by fasteners and/or zippers.

In embodiments, a stabilizing plate 110 may be pressed or engaged against a filler to spread the weight of the mobile computing device across a large enough area of the padded cushion 105 to provide stability to support the mobile computing device 100. In embodiments, a stabilizing plate 110 may cover greater than 75% of a top surface area of a padded cushion 105 in order to provide support for the mobile computing device 120. In embodiments, a stabilizing plate 110 may cover greater than 50% of a top surface area of a padded cushion 105 in order to provide support for larger mobile computing devices 120. In embodiments, a stabilizing plate 110 may have a length between 7 inches and 12 inches, a width of 7 inches or 12 inches and/or a depth between 2 inches and 5 inches. In embodiments, a stabilizing plate 110 may be made or comprised of a cardboard or thick paper product. In embodiments, a stabilizing plate 110 may be made of a plastic or a hard plastic. In embodiments, a stabilizing plate 110 may be made of a light metal, a thin metal, a thin wood, a thin plywood, and/or a thin rubber. In embodiments, different embodiments may require different materials having less or more strength in order to support a support stand and/or vertical support assembly 115 and a mobile computing device.

In embodiments, a vertical support assembly 115 may comprise a vertical stand or post 116 and a circular joint or ball 117. In embodiments, a vertical support assembly 115 may be attached to a stabilizing plate 110 via an adhesive and/or may be connected via fasteners and/or a suction device. In embodiments, a vertical support assembly 115 may be screwed into a receptacle of a stabilizing plate 110. In embodiments, a vertical stand or post 116 and/or a ball or circular joint 117 may be one piece. In embodiments, each of the vertical stand or post 116 and/or a ball or circular joint 117 may be separate pieces connected to each other through a strong connection such as a weld and/or a strong adhesive. In embodiments, a vertical stand or post 116 and/or a ball or circular joint 117 may be made of a lightweight metal (7 ounces or less in weight). In embodiments, a vertical stand or post 116 and/or a ball or circular joint 117 may be made of a metal weighing 1 pound or less, or 2 pounds or less. In embodiments, a vertical stand or post 116 and/or a ball or circular joint 117 may be made of a plastic, a light metal, or wood. In embodiments, a ball or circular joint 117 may be made of a rubber and/or may be a suction device. In embodiments, a ball or circular joint 117 may be made of a magnetic material. In embodiments, a vertical support assembly 115 may have dimensions, where the dimensions have a height range of 5 inches to 8 inches and a width range of 1 inch to 5 inches. In some embodiments, a ball or circular joint 117 may have a height and/or width of 1 inch. In some embodiments, a ball or circular joint 117 may have a diameter of one inch. In embodiments, a ball or circular joint 117 may have a height and/or width ranging from 0.5 inches to 3 inches. In some embodiments, a ball or circular joint 117 may have a diameter ranging from 0.5 inches to 2 inches.

In embodiments, a disk assembly, pivoting joint or a gripping member 125 may be connected to a ball or circular joint 117 of the vertical support assembly 115. In embodiments, a disk assembly or gripping member 125 may allow up to 360-degree rotation around the ball or circular joint 117. In embodiments, a disk assembly or gripping member 125 may be a ring with a hollow center. In embodiments, a hollow center of a disk assembly or gripping member 125 may allow for connection or coupling to the ball or circular joint 117 and swiveling about the ball or circular joint 117. In embodiments, a disk assembly, pivoting joint and/or a gripping member 125 may comprise an outer raised ring of outer material with a center circular or indented/depressed area. In embodiments, a ball or circular joint 117 may fit into a center circular or indented/depressed area. Because the ball or circular joint 117 fits into a depressed/indented area, movement of up to 360 degrees in a left or right direction and/or up or down direction may occur.

In embodiments, a disk assembly, pivoting joint or gripping member 125 may be made of a lightweight metal. In embodiments, a disk assembly, pivoting joint or gripping member 125 may be magnetic to allow connection to the ball or circular joint 117. Also, a disk assembly, pivoting joint or gripping member 125 may be coupled to a surface of the mobile computing device via a magnetic connection to hold the mobile computing device in a proper position. In these embodiments, the back surface of the mobile computing device would need to be a metallic surface or another material that has magnetic properties (or simply adhere a magnetic plate to the back of the computing device or adhere a magnetic to a case for the computing device). In embodiments, a disk assembly, a pivoting joint or gripping member 125 may be a suction device to allow gripping to a mobile computing device which has a surface to engage the suction device. In embodiments, a gripping member 125 may comprise an adhesive material (e.g., such as the adhesive on a yellow sticky note or a stronger industrial adhesive) to which a mobile computing device may be attached. In embodiments, the gripping member 125 may utilize Velcro if there is Velcro on the mobile computing device. In embodiments, a disk assembly, pivoting joint or gripping member 125 may have a diameter range of 1 inch to 3 inches and a width range of ¼ inch to 1 inch.

FIG. 1A further illustrates a padded cushion 105 with a wall connection plate 260. In embodiments, a wall connection plate 260 may allow a mobile computing device stand 100 to connect or be attached to a wall surface in a room. In embodiments, a wall surface may be a vertical wall that is located near a couch and/or bed. In embodiments, a wall connection plate 260 may be magnetic and may attach to a matching metal plate on a wall surface. In embodiments, a wall connection plate 260 may be a suction device and may attach to a receiving plate or surface on a wall surface. In embodiments, a wall connection plate 260 may be attached to a side surface of a padded cushion 105 or to 125. In embodiments, a wall connection plate 260 may be attached to a bottom surface of a padded cushion 105. In embodiments, a wall connection plate 260 may comprise an adhesive material that is coupled to an adhesive surface or receiving surface of a wall. In embodiments, the wall connection plate 260 may include Velcro if the wall surface has a matching or mating Velcro piece. In embodiments, the wall connection plate 260 may be adhered to the padded cushion 105, attached to padded cushion 105 and/or integrated within the padded cushion 105 (e.g., sewn into the fabric of the padded cushion).

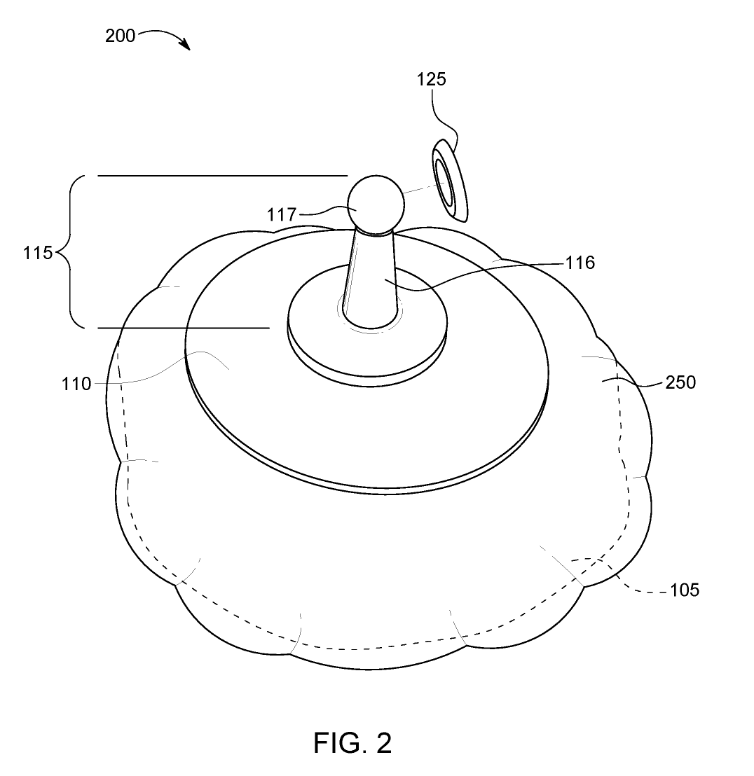

FIG. 2 illustrates another mobile computing device stand according to embodiments. In embodiments, a mobile computing device stand 200 comprises all of the elements of the mobile computing device stand illustrated in FIG. 1 in addition to a radiation protective shield 250. In embodiments, a radiation protective shield may protect a user of a mobile computing device stand from radiation generated by a mobile computing device. In embodiments, a radiation protective shield 250 may be attached to a bottom surface of a padded cushion 105. In embodiments, a radiation protective shield 250 may be attached to a top surface of a padded cushion 105 and may cover a portion, most and/or all of a padded cushion 105 (as is illustrated in FIG. 2). In embodiments, a radiation protective shield 250 may comprise one or more radiation stickers attached to a padded cushion 105, a mounting plate 110 and/or a vertical support assembly 115. In embodiments, a radiation protective shield 250 may comprise a thin material attached to a top or bottom of a padded cushion 105. In embodiments, a radiation protective shield 250 may comprise a thin material having radiation stickers attached thereto and/or integrated within. This is especially advantageous since many mobile computing devices include wireless transceivers that generate unknown amounts of radiation and this protects the user or operator from significant levels of this generated radiation.

FIG. 3 illustrates a mobile computing device stand including a wedge-shaped padded cushion according to embodiments. In embodiments, a mobile computing device stand 300 comprises a wedge-shaped padded cushion 305, a mounting plate 310, a support assembly 315 and/or a disk assembly, gripping member, or a pivoting assembly 325. FIG. 3 also shows positioning of a mobile computing device with respect to a disk assembly, gripping member, or a pivoting joint 325. In embodiments, a padded cushion 305 may be wedge-shaped because this allows additional rotation of a mobile computing device about a disk assembly, gripping member or pivoting joint 325. In embodiments, a downward slope of a top surface of a wedge-shaped padded cushion 305 may allow a mobile computing device 325 to rotate further clockwise from a top to a bottom direction. In embodiments, this provides a better viewing angle for a user or operator if the user or operator is in front of the padded cushion 305. In FIG. 3, the support assembly 315 may comprise a vertical support column and a ball as was described above with respect to FIG. 1.

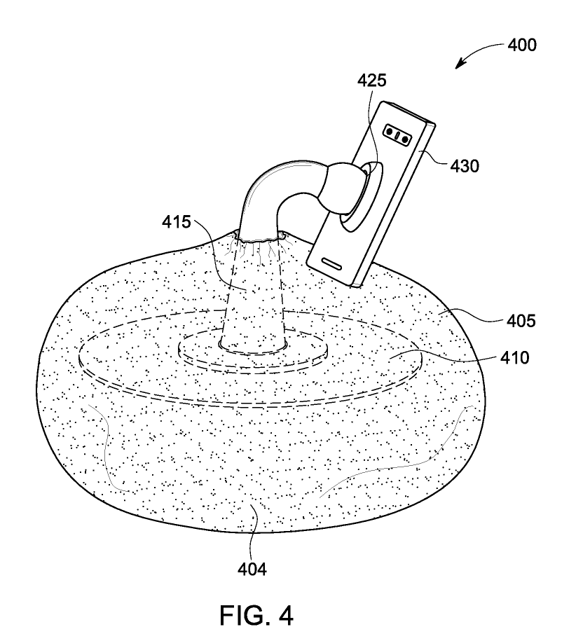

FIG. 4 illustrates a mobile computing device stand according to additional embodiments. In embodiments, more stability may be needed when an individual is lying down. In embodiments, the mobile computing device stand may lower its center of gravity by moving a location of a mounting plate inside a padded cushion. In embodiments, the mounting plate may be positioned or installed between ⅓rd to ½ the height of a padded cushion. This allows the mobile computing device stand to have a base of filling material to support the mounting plate and still have additional filling material on top of the mounting plate. In embodiments, the mobile computing device stand 400 may comprise a padded cushion 405 (which may be a circular or oval cushion), filling material 404, a mounting plate 410, a support assembly 415, and/or a disk assembly, gripping member, or a pivoting assembly 425. In embodiments, the padded cushion 405 may be made of a burlap, a cloth and/or a cotton or other natural material. In embodiment, the padded cushion 405 may be filled with filler material 404, such as a natural or sustainable grain or product such as barley, other wheat varieties, oats, different varieties of beans, and/or Styrofoam beads, or a synthetic weighted filler. In embodiments, the barley or filler material 404 may be substantial and thick enough to support a mounting plate and not have the mounting plate 410 move a large amount as the mobile computing device stand is being utilized. In embodiments, the mounting plate 410 may be installed on top of a portion of the barley or filler material 404 inside the padded cushion 405. In embodiments, the support assembly 415 may be connected to the mounting plate 410 via a fastener. In embodiments, a screw connects the mounting plate 410 to the support assembly 415 and is inserted through a bottom of the mounting plate 410 to the bottom of the support assembly 415. In embodiments, as shown in FIG. 4, a part of the support assembly 415 is also positioned and/or installed inside a padded cushion 405. In embodiments, more than ½ of the support assembly (or in an alternative embodiment between ⅓rd and ⅔rd of the support assembly) may be installed inside a padded cushion 405. Thus, part of the barley or filler material 404 may be positioned around (or surrounding) the support assembly 415, as illustrated in FIG. 4. In embodiments, as is illustrated in FIG. 4, a support assembly 415 is arched downward (e.g., a reference number 416 shows a curved portion of the support assembly 415 that is arched downward). This means that the disk assembly, gripping member or pivoting assembly 425 may be pointed in a slightly downward direction. In embodiments, the mobile computing device 430 may be connected or coupled to the disk assembly or pivoting assembly 425. In embodiments, the mobile computing device 430 (as is shown in FIG. 4) may also be pointed or positioned in a slightly downward direction. In embodiments, this is different than other mobile computing device stands where the disk assembly or pivoting assembly 425 and/or mobile computing device 430 are positioned or pointed in an upward direction. In embodiments, this is because the mobile computing device stand 400 may be utilized when an individual is lying down and the mobile computing device stand 400 is resting on a chest or stomach of a user or operator and the head is at a same level as the chest or stomach of the user. In some embodiments, the disk assembly or pivoting assembly 425 may also be used when a user is sitting and the rotation allows for the mobile computing device to be positioned or faced upwards. Thus, a mobile computing device 430 may need to pointed to slightly downward in order for a user or operator to see and view and/or operate the mobile computing device 430 while it is coupled, connected, adhered and/or attached to the mobile computing device stand 400 (e.g., the disk assembly or pivoting assembly 425 of the mobile computing device stand 400). In FIG. 4, the support assembly 415 may be comprised of a support pole and a ball or joint as described above in FIG. 1. In embodiments, a mounting plate 410 may have a diameter between a range of 3 to 7 inches (e.g., may be 5 inches). In embodiments, a mobile computing device stand 400 may have a diameter between a range of 5 to 9 inches (e.g., may be 7 inches).

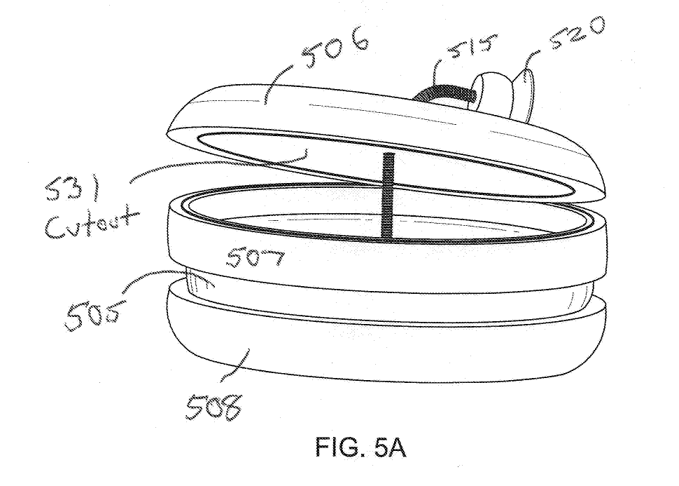

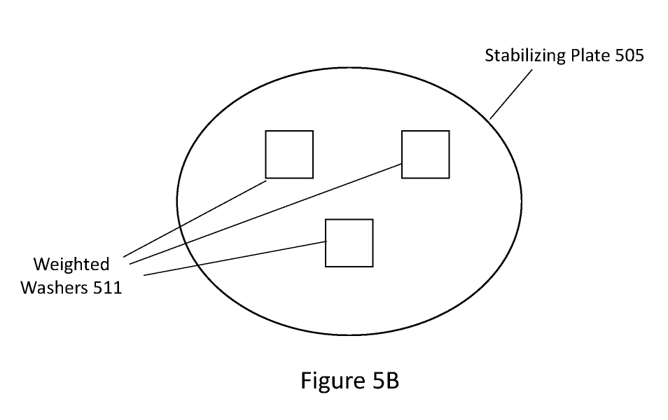

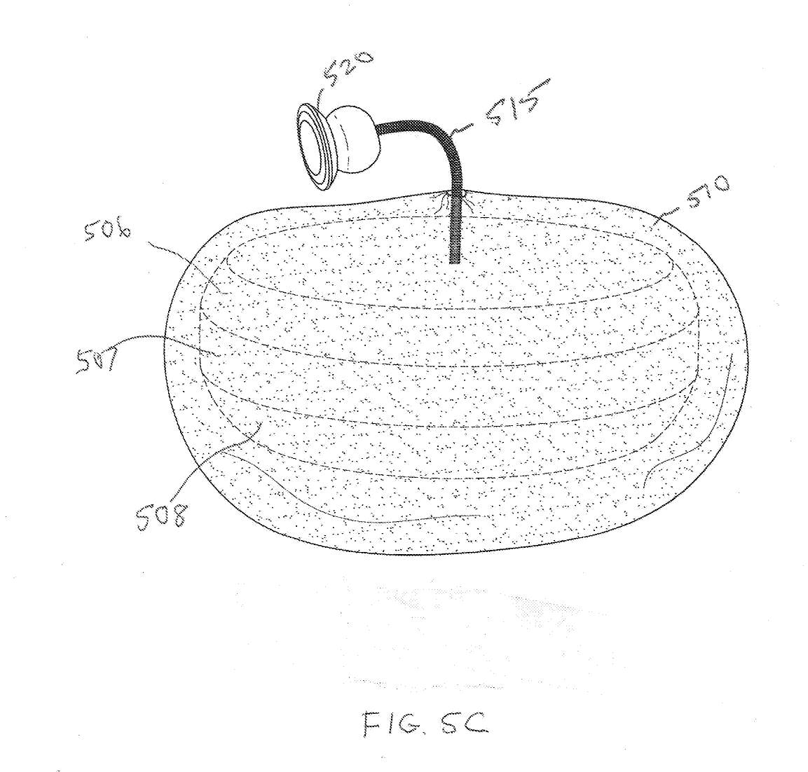

FIG. 5A illustrates a foam covering a stabilizing plate in a mobile computing device stand according to embodiments. FIG. 5B illustrates weighting plates placed on a stabilizing plate in a mobile computing device stand according to embodiments. FIG. 5C illustrates an additional embodiment of a mobile computing device stand including foam padding according to embodiments. In some embodiments, the padding cushion may utilize foam (or pieces of foam) to surround the stabilizing plate. In some embodiments, if the foam (or prices of foam) are utilized to surround the stabilizing plate, the padded cushion may also include additional material for weighting and/or stability. The additional matter may be glass beads and/or sand. In some embodiments, if the foam (or pieces of foam)(which may be referred to as “interior foam padding” are utilized to surround the stabilizing plate, the padded cushion may not utilize other material inside the padded cushion (e.g., weighted material). In some embodiments, the stabilizing plate may also include pieces of heavy metals (e.g., weighted washers) that are connected, attached, fastened or adhered to a surface of the stabilizing plate. In some embodiments, the pieces of heavy metal (e.g., weighted washers) may be connected, attached, fastened, or adhered to a bottom surface of the stabilizing plate.

FIG. 5A illustrates interior foam padding covering a stabilizing plate according to some embodiments. In embodiments, one or more foam cushions or padding (e.g., interior foam padding) may cover at least one surface of a stabilizing plate. In embodiments, a covering or skin of a mobile computing device stand may be thin or made of a fabric. In some embodiments, this means that a stabilizing plate made of a plastic or metal may press against a cover of the padded cushion and this may be too uncomfortable for the user. In addition, the stabilizing plate may be heavy enough or sharp enough to cut through the padded cushion cover. In the embodiment illustrated in FIG. 5A, three foam cushions or padding (interior foam padding) 506 507 and 508 may surround most or all of the surface of the stabilizing plate. In embodiments, over 75 percent of the stabilizing plate 505 may be covered by interior foam padding. In some embodiments, the interior foam padding 506 507 508 may have a thickness or width of 0.25 inches to 1.25 inches. In some embodiments, some of the interior foam padding (e.g., foam cushions 506 and 508) may have a circular shape like that of the stabilizing plate 505. In some embodiments, some of the interior foam padding (e.g., interior foam padding 506 and 508) may have a cutout 531 on a bottom surface that allows a portion of the stabilizing plate to be inserted or placed into the cutout 531. In these embodiments, the cutout 531 is only in a bottom surface of the interior foam padding and does not extend all the way through the interior foam padding. This provides a more secure fit and thus keeps a stabilizing plate 505 from moving. In some embodiments, some of the interior foam padding (e.g., interior foam padding 507) may be a circular or similar shape of material with an opening in the middle that the stabilizing plate would pass through that wraps around the circumference of the stabilizing plate 505. In these embodiments, the interior foam padding (e.g., interior foam padding 507) would be protecting and padding an outside edge of a stabilizing plate 505. In some embodiments, the interior foam padding 506 507 508 may cover surfaces of the stabilizing plate 505 and the softness and the nature of the interior foam padding keeps the stabilizing plate from cutting into the fabric of the padded cushion (the exterior padded cushion). In addition, the interior foam padding 506 507 508 are not uncomfortable or irritating to the user of the mobile computing device stand. In embodiments, the interior foam padding may be one piece with a zipper and the stabilizing plate may be inserted into the interior foam padding. In embodiments, the interior foam padding may be one or two pieces, or alternatively may be four or more pieces based at least in part of the geometry of the stabilizing plate.

FIG. 5B illustrates weighted washers on a stabilizing assembly of a mobile computing device stand according to some embodiments. In some embodiments, the stabilizing plate or assembly 505 may need additional heft or strength in order to handle mobile devices attached thereto. In order to provide additional stability or weight, weighted washers 511 (or pieces of metal) may be attached, connected, adhered or fastened to the stabilizing plate 505. In embodiments, the weighted washers 511 may be attached, connected, adhered or fastened to a bottom surface of the stabilizing plate 505. In embodiments, the weighted washers 511 may be 1 inch by 1 inch and a thickness of ¼ inch. In embodiments, the weighted washers 510 may range in length from 0.5 to 2.5 inches, from width 0.5 to 2.5 inches and may have a thickness of ⅛^{th} inch to ¾ inch. In embodiments, the weighted washers may weigh between 9 to 10 ounces. In embodiments, the stabilizing plate 505 may include two weighted washers. In some embodiments, the weighted washers may range from 0.5 to 1.5 pounds. In some embodiments, the stabilizing plate 505 may have between 1 and 6 weighted washers 511 attached, connected, coupled or adhered to in order to provided additional support and weight.

FIG. 5C illustrates a mobile communications device stand utilizing interior foam padding around a stabilizing plate according to embodiments. In some embodiments, as illustrated in FIG. 5C, the mobile computing device stand includes a padded cushion 510, a stabilizing plate 505, a vertical support assembly 515, and/or a pivoting disk assembly 520. In some embodiments, the stabilizing plate 505 may be inside the padded cushion 510. In some embodiments, a portion of the vertical support assembly 515 may be inside the vertical support assembly 520. In some embodiments, the vertical support assembly may be attached, coupled or connected to the stabilizing plate 505. In some embodiments, a pivoting disk assembly 520 may be attached, coupled or connected to the vertical support assembly 515. In some embodiments, the padded cushion 510 comprise interior foam padding 530. In some embodiments, the interior foam padding 530 may cover all or most of the stabilizing plate 505 as shown in FIG. 5A and described above. In some embodiments, the cover of the padded cushion 510 may surround or encompass the interior foam padding 530. In embodiments, there may be an opening in the cover of the padded cushion from which the vertical support assembly 515 passes through. In embodiments, the cover of the padded cushion 510 may cover more than 50% of the height of the vertical support assembly 515. In some embodiments, a section of a vertical support assembly 515 may be not be covered by the cover of the padded cushion. In some embodiments, a black paracord may be wrapped around the part or section of the vertical support assembly 515. In some embodiments, the black paracord may be comforting or easier to grip when picking up and moving the mobile computing device stand. In embodiments, foam, fabric and/or a soft plastic may encase the vertical support assembly 515.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A mobile computing device stand, comprising:
a padded cushion;
a stabilizing plate attached or connected to the padded cushion;
a vertical support assembly attached or connected to the stabilizing plate; and
a pivoting disk assembly attached or connected to the vertical support assembly, the pivoting disk assembly to magnetically attach to the mobile computing device.

2. The mobile computing device stand of claim 1, wherein the vertical support assembly comprises a vertical stand and a circular joint, the vertical stand connected to the stabilizing plate and the circular joint connected on one end to the vertical stand and attached to the pivoting disk assembly on a second end.

3. The mobile computing device stand of claim 1, the padded cushion further comprising a filling material and/or a memory foam.

4. The mobile computing device stand of claim 1, the padding cushion comprising a wedge-shaped base.

5. The mobile computing device stand of claim 1, wherein the stabilizing plate covers greater than 75 percent of a top surface of the padded cushion.

6. The mobile computing device stand of claim 2, wherein the disk assembly to allow rotation around the circular joint up to 360 degrees.

7. The mobile computing device stand of claim 1, the padded cushion further comprising a wall connection plate, the wall connection plate to attach the padded cushion to a wall surface.

8. The mobile computing device stand of claim 1, further comprising a radiation protection shield, the radiation protection shield to attach to a surface of the padded cushion.

9. A mobile computing device stand, comprising
a padded cushion;
a filling material, the filling material inside the padded cushion;
a mounting plate, the mounting plate positioned inside the padded cushion;
a supporting assembly, the supporting assembly connected to the mounting plate, a portion of the supporting assembly being located in the padded cushion and a remainder of the supporting assembly exiting out a top surface of the padded cushion; and
a disk assembly, the disk assembly attached to the supporting assembly and also attached to a mobile computing device.

10. The mobile computing device stand of claim 9, where in the padded material is made of a burlap material, a cloth material or cotton material.

11. The mobile computing device stand of claim 9, wherein the filler material is a natural or sustainable grain or product.

12. The mobile computing device stand of claim 9, wherein the mounting plate is installed on top of a majority of the filler material.

13. The mobile computing device stand of claim 9, wherein the mounting plate is connected to the support assembly via a screw.

14. The mobile computing device stand of claim 9, wherein more than ½ of the support assembly is installed inside the padded cushion.

15. The mobile computing device stand of claim 1, wherein a portion of the support assembly is curved downward.

16. The mobile computing device stand of claim 15, wherein the disk assembly and the attached mobile computing device are also positioned in a downward direction.

17. A mobile computing device stand, comprising:
a stabilizing plate attached or connected to the padded cushion;
a padded cushion, the padded cushion including interior foam padding, the interior foam padding positioned inside the padded cushion, the interior foam padding covering the stabilizing plate;
a vertical support assembly attached or connected to the stabilizing plate; and
a pivoting disk assembly attached or connected to the vertical support assembly, the pivoting disk assembly to magnetically attach to a mobile computing device.

18. The mobile computing device stand of claim 17, wherein the interior foam padding is two or more pieces.

19. The mobile computing device stand of claim 17, further comprising one or more weighted washers, the one or more weighted washers attached to a bottom surface of the stabilizing plate.

20. The mobile computing device stand of claim 17, wherein the interior foam padding has two or more pieces and at least one of the pieces has a cutout on a bottom surface that allows the stabilizing plate to rest in the cutout.
